(19) United States
(12) Patent Application Publication
(10) Pub. No.: US 2010/0085832 A1
(43) Pub. Date: Apr. 8, 2010

(54) Rotary Shaft Seal Arrangement for Mixing Bowl

(75) Inventor: Dale K. Wells, Dayton, OH (US)

Correspondence Address: THOMPSON HINE LLP;Intellectual Property Group, P.O Box 8801, DAYTON, OH, 45401-8801, US

(73) Assignee: IIIinois Tool Works Inc., Glenview, IL (US)

(21) Appl. No.: 12/570,060

(22) Filed: Sep. 30, 2009

Related U.S. Application Data
(60) Provisional application No. 61/103,093, filed on Oct. 6, 2008.

(51) Int. Cl. B01F 7/02; F16J 15/18

(52) U.S. Cl. 366/99; 277/510

(57) ABSTRACT

A mixer arrangement includes a mixer bowl, an agitator within the mixer bowl and a shaft extending through a wall of the mixer bowl for moving the agitator. A seal assembly is associated with the shaft at an external side of the mixer bowl wall. The seal assembly includes a boot component disposed about the shaft, the boot component formed of a resiliently compressible material. A boot compression component is disposed about the shaft and moveable along the shaft between a seal position that urges the boot component toward the mixer bowl wall and a release position away from the boot component. A linkage is connected to the boot compression component and has an over center orientation for holding the boot compression component in the seal position.

### CROSS-REFERENCE

This application claims the benefit of U.S. Provisional Application Ser. No. 61/103,093, filed Oct. 6, 2008, the entirety of which is hereby incorporated by reference.

### TECHNICAL FIELD

This application relates generally to dough mixers and more particularly to a rotary shaft seal arrangement for a mixing bowl.

### BACKGROUND

Commercial dough mixers are provided for mixing large amounts of dough at one time. In some instances, it may be desirable to mix, for example, between about 400 and 3,200 pounds of dough. An agitator is often used in mixing the dough. The agitator is driven by a drive shaft operatively linked to a motor.

Shaft seals are known for use in sealing around shafts. However, seals placed around shafts can generate heat due to friction. Bread dough is often mixed at controlled temperatures (e.g., about 78° F. to about 80° F.). During mixing, friction and viscous shear can cause temperature to rise in the dough, which can cause the dough to become sticky and difficult to process.

### SUMMARY

In an aspect, a mixer arrangement includes a mixer bowl, an agitator within the mixer bowl and a shaft extending through a wall of the mixer bowl for moving the agitator. A seal assembly is associated with the shaft at an external side of the mixer bowl wall. The seal assembly includes a boot component disposed about the shaft, the boot component formed of a resiliently compressible material. A boot compression component is disposed about the shaft and moveable along the shaft between a seal position that urges the boot component toward the mixer bowl wall and a release position away from the boot component. A linkage is connected to the boot compression component and has an over center orientation for holding the boot compression component in the seal position.

In another aspect, a shaft seal arrangement for a dough mixer includes a rotor disk including a rear wall and a lip extending outwardly from the rear wall in an axial direction thereby defining a recess. The rear wall has an opening extending therethrough sized to receive an agitator shaft of the dough mixer. A boot component is formed of a resiliently compressible material. The boot component is sized for location within the recess of the rotor disk and has an opening extending therethrough sized to receive the agitator shaft of the dough mixer. A sealing hub includes an inner wall and a lip extending outwardly from the internal wall in an axial direction thereby defining a recess. The inner wall of the sealing hub has an opening extending therethrough sized to receive the agitator shaft of the dough mixer. A clamp is configured to clamp securely to the agitator shaft of the dough mixer such that the clamp rotates with the agitator shaft during operation of the dough mixer. A moveable linkage connects the clamp to the sealing hub. The moveable linkage has a retracted configuration that locates the sealing hub nearer to the clamp and an extended configuration that locates the sealing hub further from the clamp. The linkage allows the sealing hub to move axially along the agitator shaft to release pressure against the boot component in the retracted configuration and to apply pressure against the boot component in the extended configuration.

The details of one or more embodiments are set forth in the accompanying drawings and the description below. Other features, objects, and advantages will be apparent from the description and drawings.

### BRIEF DESCRIPTION OF THE DRAWINGS

FIG. 1 is a front view of an embodiment of a mixer;

FIG. 2 is a perspective view of an embodiment of a rotary shaft seal arrangement;

FIGS. 3 and 4 are side views of the rotary shaft seal arrangement of FIG. 2;

FIG. 5 is a diagrammatic section view of the rotary shaft seal arrangement of FIG. 2;

FIG. 6 is a perspective view of an embodiment of a rotary disk for use with the rotary shaft seal arrangement of FIG. 2;

FIG. 7 illustrates various views of an embodiment of a boot component for use with the rotary shaft seal arrangement of FIG. 2;

FIG. 8 illustrates various views of an embodiment of a sealing hub for use with the rotary shaft seal arrangement of FIG. 2;

FIG. 9 illustrates various views of an embodiment of a clamp member for use with the rotary shaft seal arrangement of FIG. 2;

FIG. 10 illustrates various views of an embodiment of a linkage component for use with the rotary shaft seal arrangement of FIG. 2;

FIG. 11 illustrates the rotary shaft seal arrangement of FIG. 2 in a release configuration; and

FIG. 12 illustrates an embodiment of a method of installing the rotary shaft seal arrangement of FIG. 2.

### DETAILED DESCRIPTION

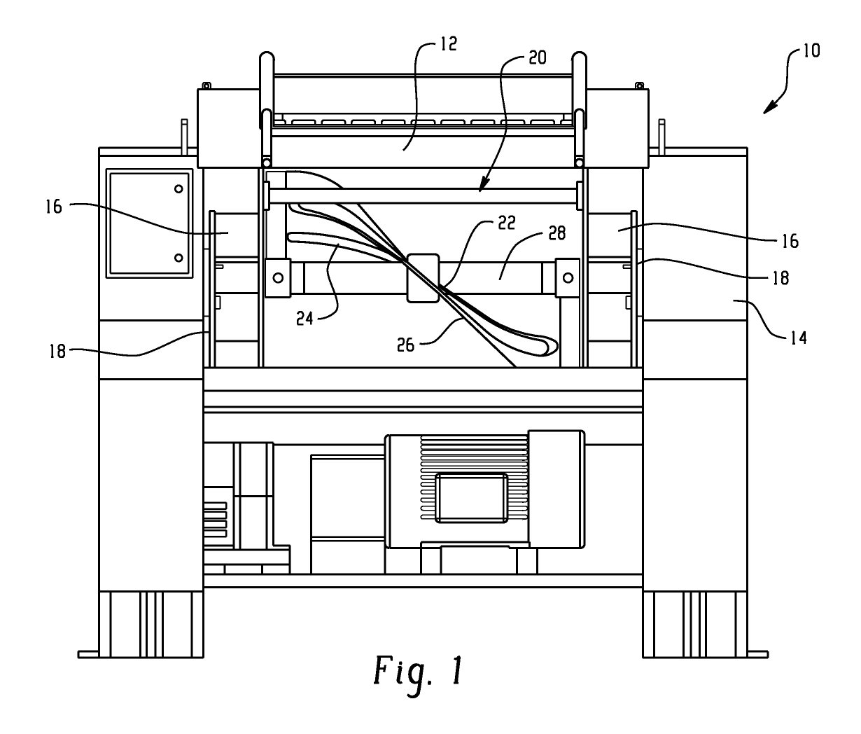

Referring to FIG. 1, a mixer 10 includes a mixing bowl 12 mounted within a cabinet 14. The mixing bowl 12 is an open top 20 arrangement that, in this illustration, is rotated to a sideways position. The mixing bowl 12 is supported at each end by support members 16 that are mounted to a support plate 18. An agitator 22 is rotatably mounted within the mixing bowl 12. The agitator 22 includes a pair of mixing arms 24 and 26 and a rotatable shaft 28 that supports and rotates the mixing arms 24 and 26 during a mixing operation. While agitator 22 is shown by FIG. 1, various agitator assemblies can be utilized including refrigerated agitator assemblies such as that described by U.S. Pat. No. 6,047,558.

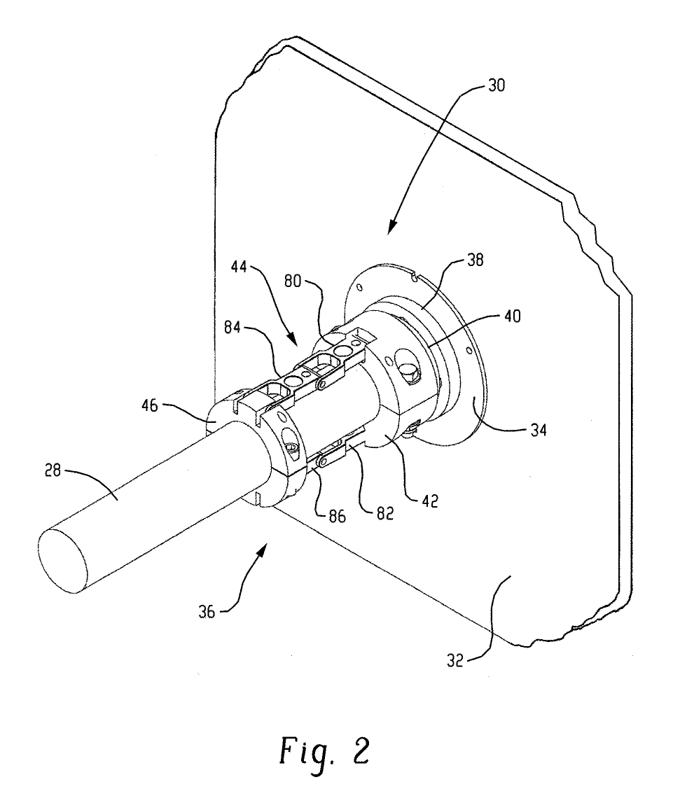

Referring to FIGS. 2-4, a rotary shaft seal arrangement 30 seals against an outer side 32 of the mixing bowl 12. The rotary shaft seal arrangement 30 includes a stationary stator plate 34 formed of a low friction material such as polytetrafluoroethylene (PTFE) that is fastened to the side 32 of the mixing bowl and a rotating seal assembly 36 that seals against the stator plate and rotates with the shaft 28. The seal assembly 36 includes a rotor disk 38 and a boot component 40 that is compressed between the rotor disk and a sealing hub 42. The sealing hub 42 is pressed against the boot component 40 using an over center toggle linkage 44 connected to a clamp member 46 fixedly secured to the rotatable shaft 28.

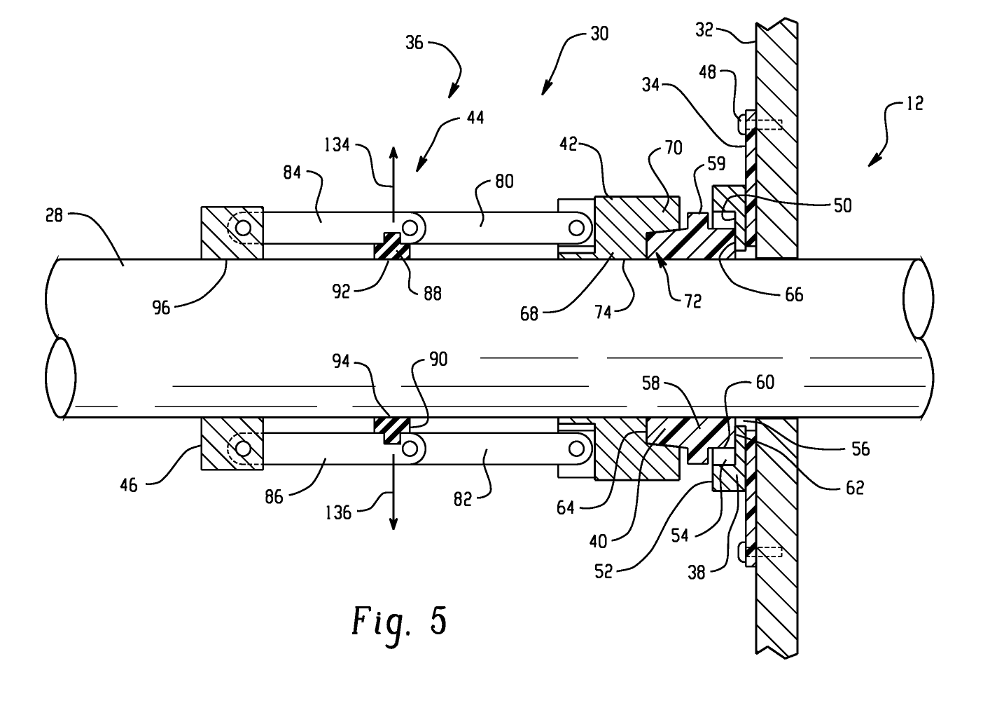

FIG. 5 shows a section view of the rotary shaft seal arrangement 30 in a seal configuration. Stationary stator plate 34 is fastened to the side 32 of the mixing bowl 12 by any suitable method such as fasteners 48. The rotor disk 38 includes a rear wall 50 and a peripheral lip 52 that extends axially outward from the rear wall forming a recess 54. The rotor disk 38 is formed of a relatively hard material such as stainless steel. An opening 56 is provided in the rear wall 50 through which the shaft 28 extends. The opening 56 is sized slightly larger than an outer diameter of the shaft 28 so that the rotor disk 38 can slide or move axially along the shaft 28.

The recess 54 is sized to receive one end the boot component 40. The boot component 40 is formed of a resiliently compressible material such as plastic or rubber (e.g., silicone). The boot component 40 includes a body 58 and an extension or rib 59 that extends about a periphery 60 of the body. The body 58 includes a rear surface 62 and a front surface 64. In one embodiment, the body 58 has an outer diameter that is less than an inner diameter of the recess 54 such that at least a portion of the body is located within the recess 54. The rear surface 62 of the body 58 is pressed against a seating surface 66 that is formed in the recess 54 by the rear wall 50 of the rotor disk 38.

As noted above, the boot component 40 is compressed between the rotor disk 38 and the sealing hub 42. The sealing hub 42 includes an inner wall 68 and a peripheral lip 70 that extends axially outward from the inner wall forming a recess 72 that faces the rotor disk recess 54. The sealing hub 42 is formed of a relatively hard material such as polyoxymethylene (POM) or stainless steel. An opening 74 is provided through the inner wall 68 through which the shaft 28 extends. The opening 74 is sized slightly larger than an outer diameter of the shaft 28 so that the sealing hub 42 can slide or move axially along the shaft 28.

In the illustrated embodiment, the recess 72 is frustoconical and formed by an inner surface that tapers radially inwardly when moving from the lip end toward the inner wall 68. This frustoconical arrangement of the recess 72 applies both radial and axial component forces against the boot component 40 when the sealing hub 42 is pressed toward the bowl and against the boot component.

The sealing hub 42 is pressed against the boot component 40 by linkage 44. In the illustrated embodiment, the linkage 44 is an over center toggle arrangement that is formed by a pair of first linkage components 80 and 82 rotatably/ pivotally connected at one end to the sealing hub 42 and a pair of second linkage components 84 and 86 rotatably/pivotally connected at one end to the first linkage components and at the other end the clamp member 46. The linkage 44 is an over center toggle arrangement in that the first and second linkage components 80, 82, 84 and 86 extend slightly radially inwardly toward the shaft 28 at the connection point between the first linkage components and the second linkage components. A foot 88 and 90 (e.g., formed of rubber) is connected to the second linkage components 84 and 86. Each rubber foot 88 and 90 includes a surface 92 and 94 that abuts the periphery of the shaft 28 and supports the linkage 44. The rubber feet 88 and 90 support the linkage 44 to provide the over center toggle arrangement as shown in FIGS. 2-5.

The linkage 44 is rotatably connected to clamp member 46. The clamp member 46 is fixedly secured directly to the shaft 28 such that it cannot move axially along the shaft. The clamp member 46 includes an opening 96 that is sized to lock the clamp member to the shaft 28 such that the clamp member rotates with the shaft during operation.

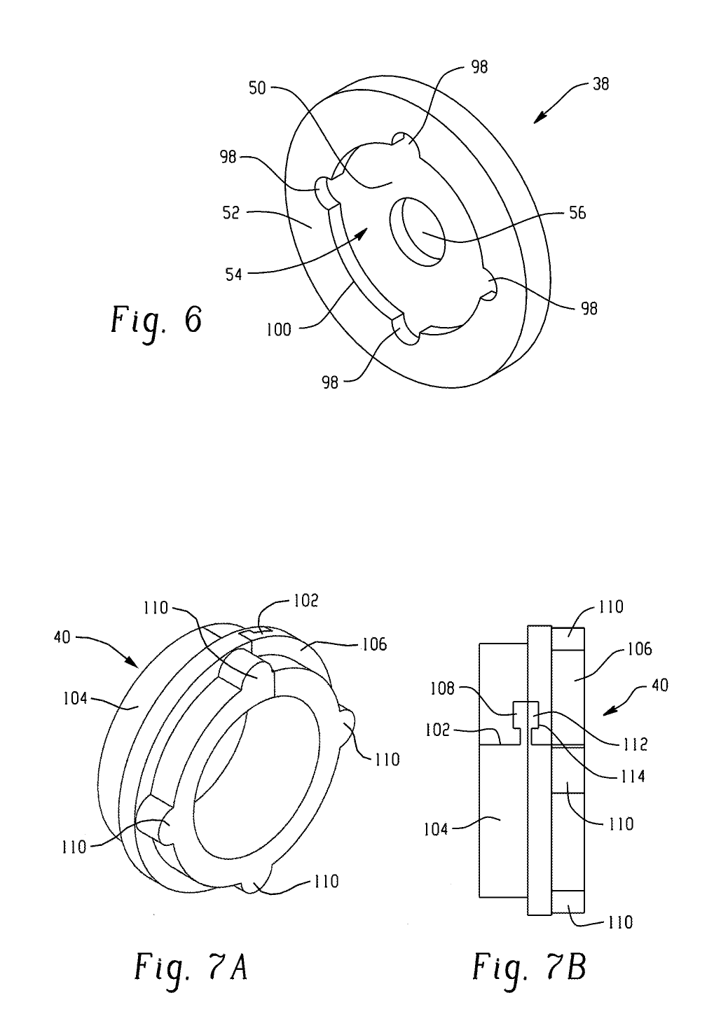

FIG. 6 illustrates the rotor disk 38 in isolation. The rotor disk 38 is a round, single piece and includes the rear wall 50, the lip 52 extending axially outward from the rear wall forming a recess 54 and the opening 56 in the rear wall 50. Notches 98 are formed along an inner edge 100 of the lip 52. The notches 98 are spaced apart from each other and distributed along the inner edge 100.

Referring now to FIGS. 7A & 7B showing the boot component 40 in isolation, the boot component is split along split line 102 in order to separate region 104 from region 106. A connection feature 108 (e.g., projection 112 and slot 114) is provided, which provides resistance against the regions 104 and 106 being separated. The split feature of the boot component 40 facilitates its removal from the shaft for cleaning and/or replacement. The boot component 40 includes radially outwardly extending scallops 110 spaced about the periphery of the boot component that are sized and arranged to be received within the notches 98 of the rotor disk 38. The scallops 110 and notches 98 cooperate so that the boot component 40 and rotor disk 38 rotate together during use.

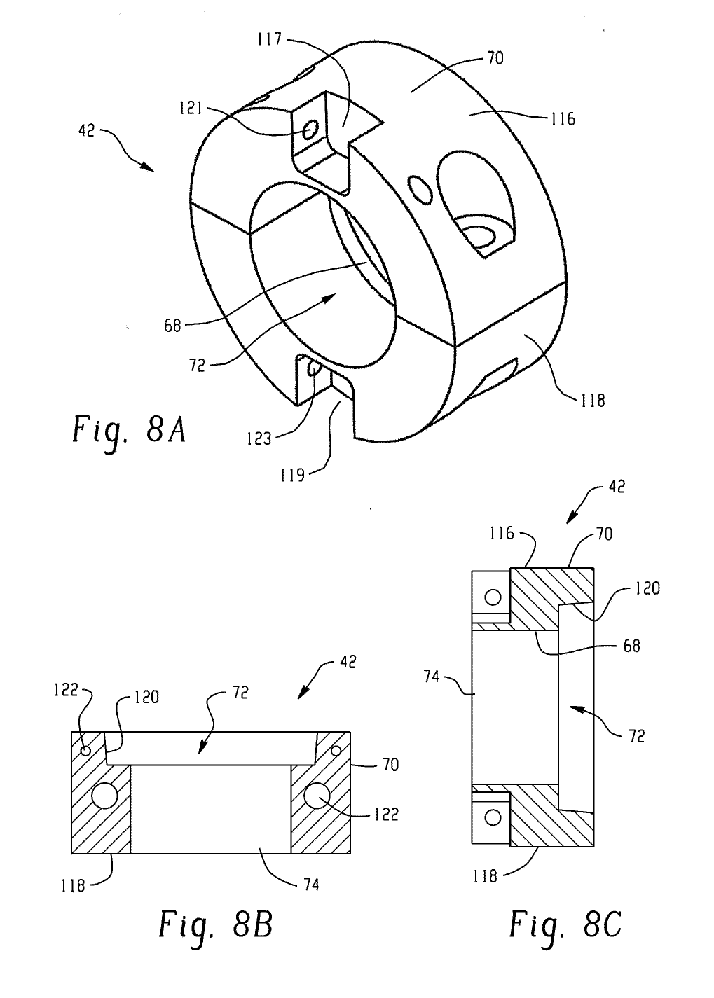

Referring to FIGS. 8A-8C, the sealing hub 42 includes the inner wall 68, the lip 70 that extends axially outward from the inner wall forming the recess 72 and the opening 74 through the inner wall 68. The sealing hub 42 is formed of two separable halves 116 and 118 that are connected together by fasteners, or any other suitable method. The frustoconical recess 72 can be seen with tapered inner surface 120. Openings 122 are provided in the halves 116 and 118 so that dowels can be inserted. Each hub half includes a recess or cutout 117 and 119 for receiving an end of linkages 80 and 82, with lateral holes 121 and 123 to receive pins/rod to provide the pivotal connection.

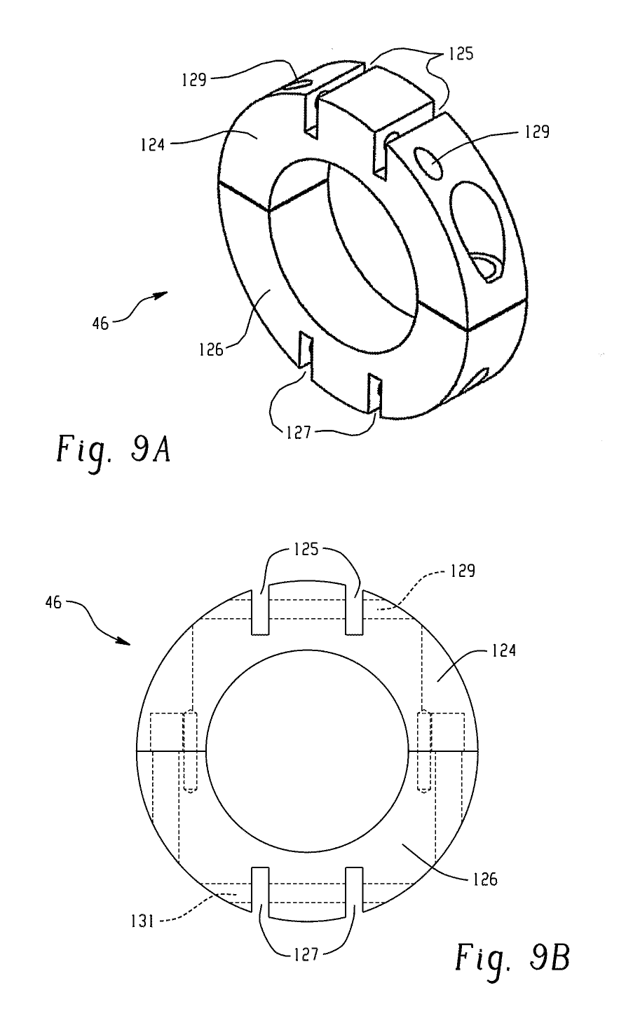

FIGS. 9A and 9B illustrate the clamp member 46. The clamp member 46 is formed of two separable halves 124 and 126 that are connected together by fasteners, or any other suitable method. As described above, the clamp member 46 is sized to be securely fastened to the shaft 28. Each clamp half includes spaced apart slots 125 and 127 fore receiving the ends of linkages 84 and 86, with lateral holes 129 and 131 to receive rods/pins to provide the pivotal connection.

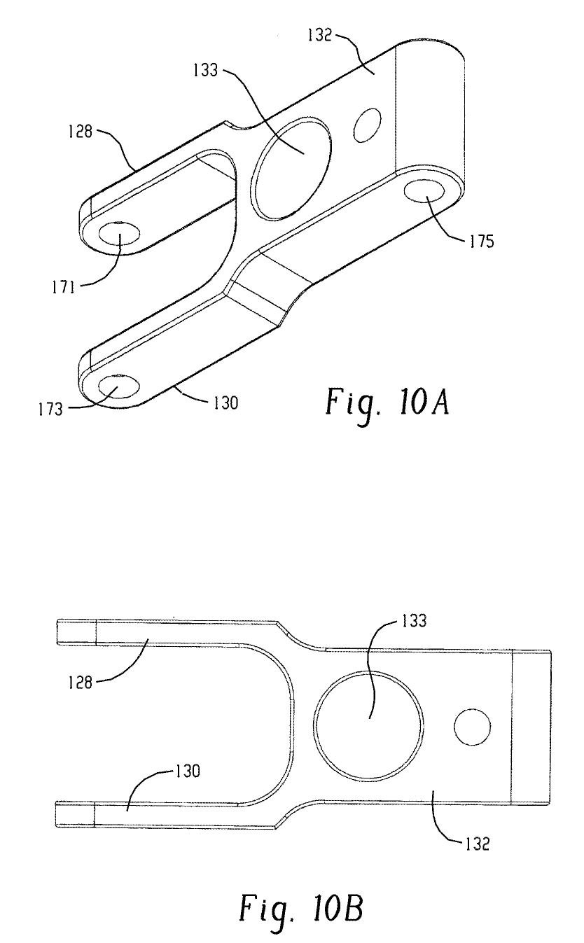

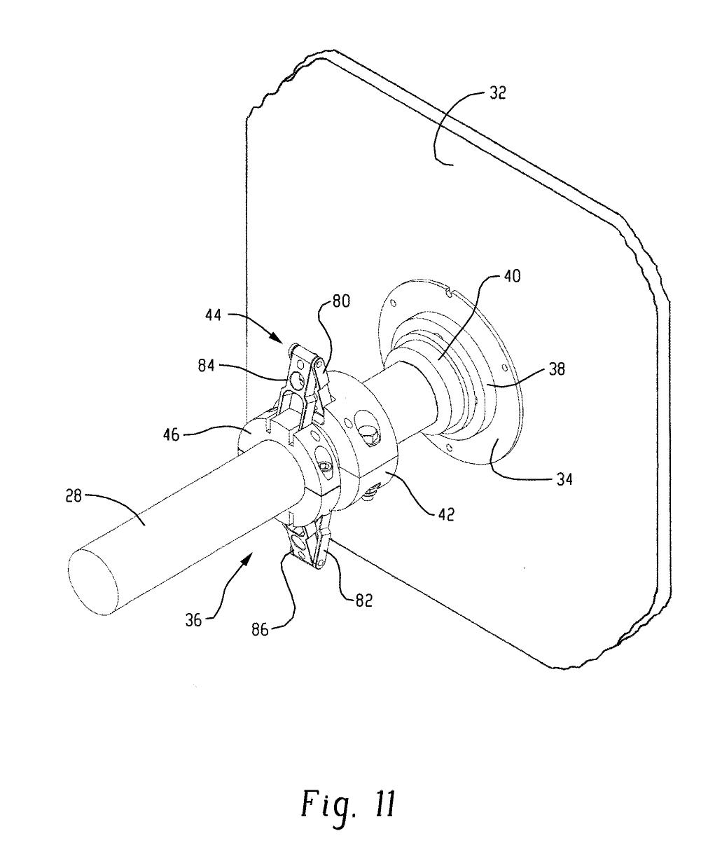

Referring to FIG. 10, en exemplary linkage component for forming the linkage 44 is illustrated. The linkage component 80, 82, 84, 86 is prong-shaped including prongs 128 and 130 and stem 132. The prongs 128 and 130 of linkage components 84 and 86 pivotally engage the slots 125 and 127 of the clamp member 46. The stem 132 of linkage components 84 and 86 fits between the prongs 128 and 130 of the linkage components 80 and 82. The stem 132 of linkage components 80 and 82 pivotally engage the recesses 117 and 119 of the hub 42. An opening 133 is provided that can receive the foot 88 or 90, which is provided in the case of linkage components 84 and 86. Both the prongs 128 and 130 and the stem include respective lateral openings 171, 173 and 175 to facilitate pivotal connection.

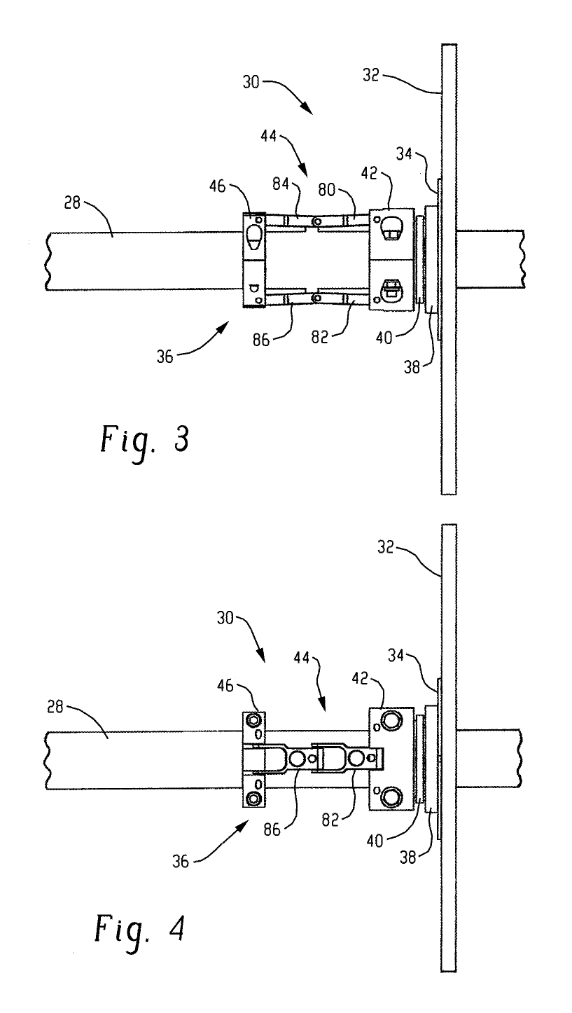

Referring now to FIGS. 2-5 and 11, the rotary shaft seal arrangement 30 has both a seal configuration (FIGS. 2 and 3) and a release configuration (FIG. 11). Referring back to FIGS. 2-5, in the seal configuration, the sealing hub 42 applies pressure against the boot component 40, compressing the boot component, forcing the boot component to bite down onto the shaft 28 and forcing the boot component against the rotor disk 38. The pressure applied to the boot component 40 also presses the rotor disk 38 against the stationary stator plate 34 thereby forming a seal. In the seal configuration, the clamp member 46, linkage 44, sealing hub 42, boot component 40 and rotor disk 38 all rotate with the shaft 28 during operation of the agitator 22.

The rotary shaft seal arrangement 30 can be placed in the release configuration by manually pulling the linkage components 80, 82, 84 and 86 away from the shaft 28 in the direction of arrows 134 and 136 (FIG. 5). Referring to FIG. 11, this pulling of the linkages 80, 82, 84 and 86 causes the sealing hub to move axially away from the boot component 40 and rotor disk 38 and toward the clamp member 46. The boot component 40 can then be removed from the shaft 28 by separating the regions 104 and 106. The rotor disk 38 can be slid axially along the shaft 38 to the size of opening 56. Placing the rotary shaft seal arrangement in the release configuration provides increased access for cleaning.

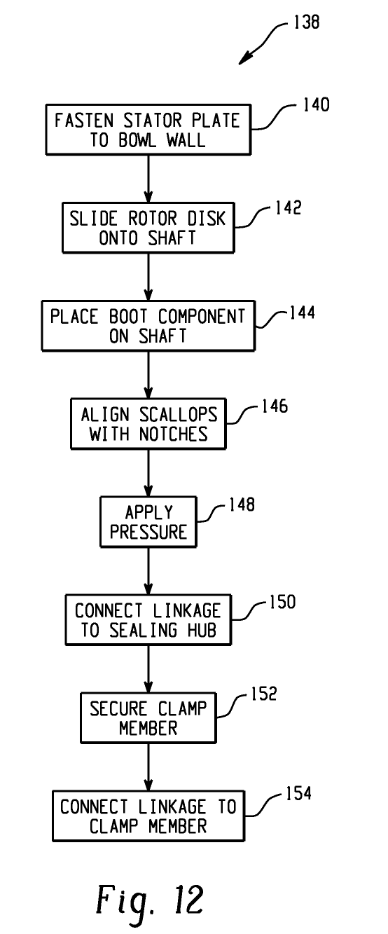

FIG. 12 illustrates a method 138 of assembling the rotary shaft seal arrangement 30 on the shaft 28. At step 140, the stationary stator plate 34 is fastened to the side wall 32 of the mixing bowl 12. The rotor disk 38 is then slid onto the shaft 28 and placed against the stationary stator plate 34 at step 142. At step 144, the boot component 40 is placed around the shaft 28 and the regions 104 and 106 are fastened together. At step 146, the scallops 110 are aligned with notches 98 and the boot component is pressed into the recess 54 of the rotor disk 38. The operator then slides the sealing hub 42 onto the shaft 28 and applies manual pressure against the sealing hub to compress the boot component between the sealing hub and the rotor disk at step 148. At step 150, the linkage 44 is connected to the sealing hub 42 and the clamp member 46 is secured to the shaft 28 at step 152. The linkage 44 is connected to the clamp member 46 at step 154.

The above-described rotary shaft seal arrangement 30 can provide a number of advantages. The rotary shaft seal arrangement 30 can be placed in both the seal configuration and the release configuration manually without any use of tools. By providing a release configuration, greater access can be provided for cleaning. The above-described rotary shaft seal arrangement 30 can also produce less heat and wear during use as compared to other shaft sealing arrangements.

It is to be clearly understood that the above description is intended by way of illustration and example only and is not intended to be taken by way of limitation, and that changes and modifications are possible. While a dough mixer is described above using the rotary shaft seal arrangement, the rotary shaft seal arrangement may be used with machinery other than dough mixers that include a rotating shaft extending through a stationary opening. Moreoever, although an over center linkage is primarily described above, it is recognized that other variations of a manually movable boot compression component support arrangement could be provided. Accordingly, other embodiments are contemplated and modifications and changes could be made without departing from the scope of this application.

What is claimed is:

1. A mixer arrangement, comprising:
a mixer bowl;
an agitator within the mixer bowl;
a shaft extending through a wall of the mixer bowl for moving the agitator;
a seal assembly associated with the shaft at an external side of the mixer bowl wall, the seal assembly including:
a boot component disposed about the shaft, the boot component formed of a resiliently compressible material;
a boot compression component disposed about the shaft and moveable along the shaft between a seal position that urges the boot component toward the mixer bowl wall and a release position away from the boot component; and
a linkage connected to the boot compression component and having an over center orientation for holding the boot compression component in the seal position.

2. The mixer arrangement of claim 1, wherein the linkage is manually moveable out of the over center orientation to pull the boot compression component toward the release position.

3. The mixer arrangement of claim 2, wherein the boot compression component comprises a hub member with a recess facing the boot component, a first end portion of the boot component compressed within the recess when the hub member is in the seal position.

4. The mixer arrangement of claim 3 including a rotor disk disposed about the shaft between the boot component and the wall of the mixer bowl, the rotor disk including a recess facing the boot component, a second end portion of the boot component compressed within the recess of the rotor disk when the hub member is in the seal position.

5. The mixer arrangement of claim 4, wherein each of the boot component, hub member, linkage and rotor disk rotate with the shaft when the hub member is in the seal position.

6. The mixer arrangement of claim 3 wherein the recess of the hub component includes a taper that urges the boot component radially inward against the shaft.

7. A mixer arrangement, comprising:
a mixer bowl;
an agitator within the mixer bowl;
a shaft extending through a wall of the mixer bowl for moving the agitator;
a seal assembly associated with the shaft at an external side of the mixer bowl wall, the seal assembly including:
a boot component disposed about the shaft, the boot component formed of a resiliently compressible material;
a boot compression component disposed about the shaft and moveable along the shaft between a seal position that urges the boot component toward the mixer bowl wall and a release position away from the boot component, the seal position closer to the mixer bowl wall than the release position; and
a manually movable boot compression component support arrangement that holds the boot compression component in the seal position and permits the boot compression component to be moved between the seal position and the release position without the use of tools.

8. The mixer arrangement of claim 7 wherein the boot compression component includes a recess facing the boot component and receiving one end of the boot component, and wherein the seal assembly further includes a rotor component disposed about the shaft and having a recess facing the recess of the boot compression component and receiving the other end of the boot component.

9. The mixer arrangement of claim 8, further comprising:
a stator plate between the rotor component and the mixer bowl wall, the stator plate secured to the mixer bowl wall.

10. The mixer arrangement of claim 9 wherein the each of the boot compression component, boot component, and rotor component rotate with the shaft when the hub member is in the seal position, the stator plate remains stationary.

11. A shaft seal arrangement for a dough mixer, the shaft seal arrangement comprising:
a rotor disk comprising a rear wall and a lip extending outwardly from the rear wall in an axial direction thereby defining a recess, the rear wall having an opening extending therethrough sized to receive an agitator shaft of the dough mixer;
a boot component formed of a resiliently compressible material, the boot component having a first end sized for location within the recess of the rotor disk and having an opening extending therethrough sized to receive the agitator shaft of the dough mixer;
a sealing hub comprising an inner wall and a lip extending outwardly from the internal wall in an axial direction thereby defining a recess, the sealing hub recess facing the rotor disk recess and sized to receive a second end of the boot component, the inner wall of the sealing hub having an opening extending therethrough sized to receive the agitator shaft of the dough mixer;
a clamp configured to clamp securely to the agitator shaft of the dough mixer such that the clamp rotates with the agitator shaft during operation of the dough mixer; and
a moveable linkage connecting the clamp to the sealing hub, the moveable linkage having a retracted configuration that locates the sealing hub nearer to the clamp and an extended configuration that locates the sealing hub further from the clamp, the linkage allowing the sealing hub to move axially along the agitator shaft to release pressure against the boot component in the retracted configuration and to apply pressure against the boot component in the extended configuration.

12. The shaft seal arrangement of claim 11 wherein the sealing hub recess is tapered to urge the second end of the boot component radially inward toward the agitator shaft when the movable linkage is in the extended configuration.
